(19) United States
(12) Patent Application Publication
(10) Pub. No.: US 2012/0247010 A1
(43) Pub. Date: Oct. 4, 2012

(54) HANGING GARDEN PLANTER APPARATUS WITH INTEGRATED DRAINAGE SYSTEM

(76) Inventor: Eric W. HUBER, San Juan Capistrano, CA (US)

(21) Appl. No.: 13/434,640

(22) Filed: Mar. 29, 2012

Related U.S. Application Data
(60) Provisional application No. 61/470,679, filed on Apr. 1, 2011.

(51) Int. Cl. A01G 9/02; A01G 13/02

(52) U.S. Cl. 47/29.1; 47/67; 47/66.6; 47/31

(57) ABSTRACT

A handing garden planter apparatus includes a backing having a top portion adapted to hang from a vertical surface, a plurality of planter pockets vertically aligned and integral with the backing, each planter pocket of the plurality of planter pockets defining an interior space adapted to house soil and plant matter therein, a drainage trough integral with the backing, the drainage tough being positioned below the plurality of planter pockets, and an integrated drainage system. The integrated drainage system is adapted to allow excess water to drain from the plurality of planter pockets to the drainage trough.

### CROSS-REFERENCE TO RELATED APPLICATION

This application is entitled to the benefit of, and claims priority to, provisional U.S. Patent Application Ser. No. 61/470,679, filed Apr. 1, 2011 and entitled “HANGING GARDEN PLANTER APPARATUS WITH INTEGRATED DRAINAGE SYSTEM,” the entirety of which is incorporated herein by reference.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE PRESENT INVENTION

1. Field of the Present Invention

The present invention relates generally to hanging garden planters, and, in particular, to hanging garden planters having integrated drainage systems.

2. Background

A need exists for improvement in hanging garden planters. This and other needs are addressed by one or more aspects of the present invention.

### SUMMARY OF THE PRESENT INVENTION

The present invention includes many aspects and features. Moreover, while many aspects and features relate to, and are described in, the context of hanging garden planters, the present invention is not limited to use only in hanging garden planters, as will become apparent from the following summaries and detailed descriptions of aspects, features, and one or more embodiments of the present invention.

Accordingly, one aspect of the present invention relates to a hanging garden planter apparatus as substantially shown and described. An exemplary such apparatus includes a backing having a top portion adapted to hang from a vertical surface, a plurality of planter pockets vertically aligned and integral with the backing, each planter pocket of the plurality of planter pockets defining an interior space adapted to house soil and plant matter therein, a drainage trough integral with the backing, the drainage tough being positioned below the plurality of planter pockets, and an integrated drainage system. Furthermore, the integrated drainage system is adapted to allow excess water to drain from the plurality of planter pockets to the drainage trough.

In a feature of this aspect of the invention, the integrated drainage system includes a plurality of semi-rigid tubes.

In another feature of this aspect, the integrated drainage system includes a drip watering system.

In yet another feature, each planter pocket includes a rigid dowel providing structural support.

In still another feature, the top portion of the backing forms a looped opened adapted to receive a support rod therethrough. In a variation of this feature, the top portion of the backing includes one or more openings that expose at least a portion of the support rod.

In another feature, the apparatus includes a support rod adapted to be inserted into a looped opening formed from the top portion of the backing

In still another feature of this aspect, the apparatus includes one or more attachment devices adapted to secure the backing to a vertical surface. In a variation of this feature, the one or more attachment devices are hooks.

In yet another feature of this aspect, the apparatus includes one or more identification labels. In a variation of this feature, the apparatus further includes one or more identification label holders.

In yet another feature, the apparatus includes a mesh covering.

In still another feature, the apparatus further includes a clear, plastic covering.

Another aspect of the present invention relates to a hanging plant growing system as substantially shown and described.

A third aspect of the present invention relates to a method of using a garden planter apparatus as substantially shown and described.

A fourth aspect of the present invention relates to an integrated drainage system as substantially shown and described.

In addition to the aforementioned aspects and features of the present invention, it should be noted that the present invention further encompasses the various possible combinations and subcombinations of such aspects and features. Thus, for example, any aspect may be combined with an aforementioned feature in accordance with the present invention without requiring any other aspect or feature.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Further features, embodiments, and advantages of the present invention will become apparent from the following detailed description with reference to the drawings, wherein:

FIG. 1 is an illustration of a preferred embodiment of a hanging garden planter apparatus in accordance with one or more aspects of the present invention;

FIG. 2 is an illustration of the hanging garden planter apparatus of FIG. 1, shown with plants growing therein;

FIG. 3 is an illustration of an enlarged view of the hanging garden planter apparatus of FIG. 2;

FIG. 4 is an illustration of an enlarged view of the hanging garden planter apparatus of FIG. 1;

FIG. 5 is an illustration of an enlarged view of the hanging garden planter apparatus of FIG. 1;

FIGS. 6-8 are illustrations of the integrated water drainage system employed by the hanging garden planter apparatus of FIG. 1;

FIG. 9 is an illustration showing the hanging garden planter apparatus folded to a compact size to facilitate easy storage;

FIG. 10 is an illustration of the hanging garden planter apparatus of FIG. 1, further including an identification label on one of the planter pockets; and

FIG. 11 is an illustration of the hanging garden planter apparatus of FIG. 1, further including a removable mesh covering.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers,” “a picnic basket having crackers without cheese,” and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, in which like numerals represent like components throughout the several views, one or more preferred embodiments of the present invention are next described. The following description of one or more preferred embodiments is merely exemplary in nature and is in no way intended to limit the invention, its implementations, or uses.

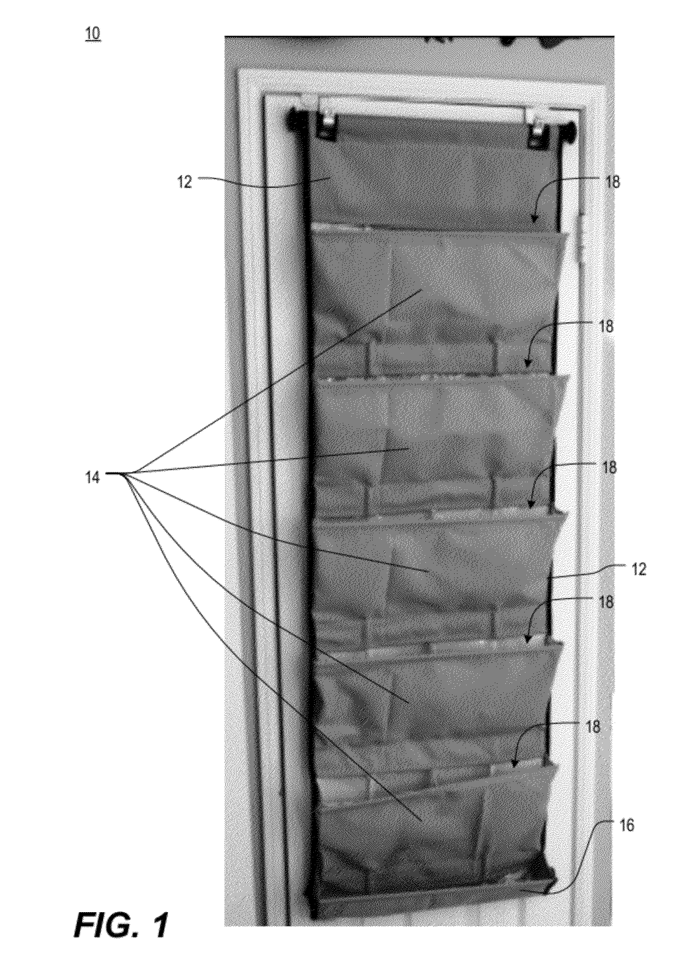

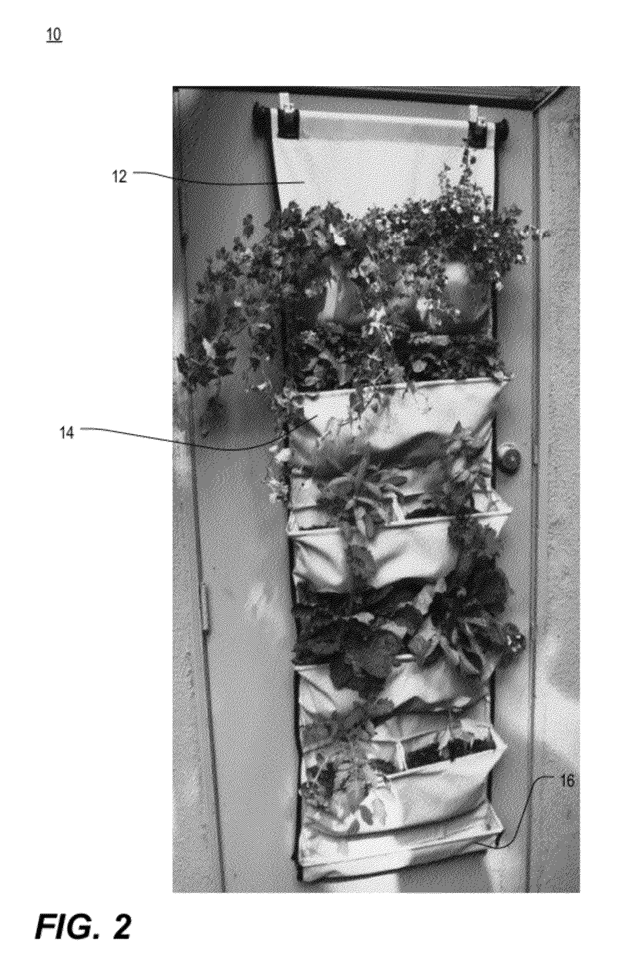

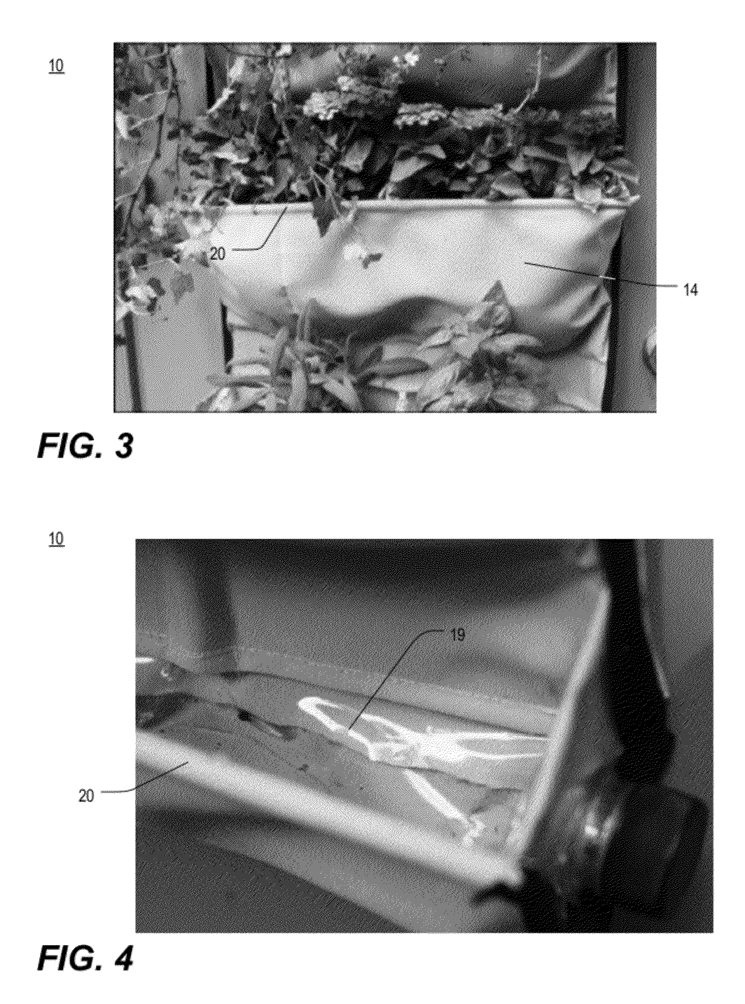

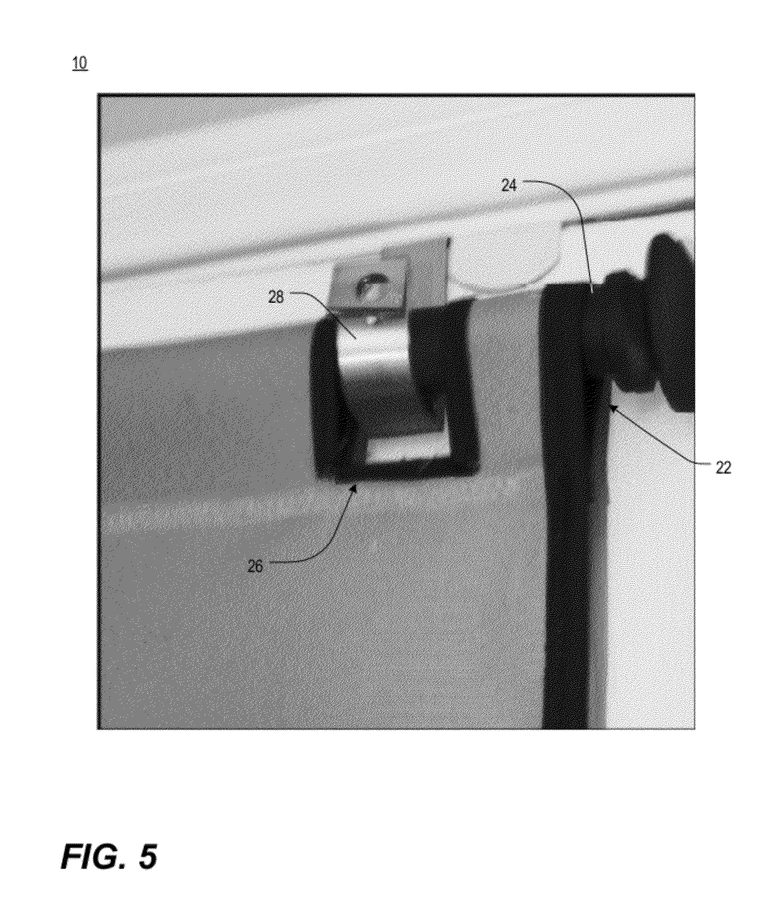

FIG. 1 is an illustration of a preferred embodiment of a hanging garden planter apparatus 10 in accordance with one or more aspects of the present invention. FIG. 2 is an illustration of the hanging garden planter apparatus 10 of FIG. 1, shown with plants growing therein. FIG. 3 is an illustration of an enlarged view of the hanging garden planter apparatus 10 of FIG. 2. FIG. 4 is an illustration of an enlarged view of the hanging garden planter apparatus 10 of FIG. 1. FIG. 5 is an illustration of an enlarged view of the hanging garden planter apparatus 10 of FIG. 1.

As seen in FIG. 1-5, the hanging garden planter apparatus 10 comprises a backing 12, a plurality of vertically aligned planter pockets 14, and a drainage trough 16. Each of the planter pockets 14 defines an interior space 18 therein adapted to house soil, plants, water, and other materials, as seen in FIG. 2. As most clearly shown in FIG. 4, each planter pocket 14 includes a waterproof lining 19 therein that prevents the water from leaking through the surface of the planter pocket 14. In at least one preferred embodiment, as seen in FIG. 3, the planter pocket 14 includes a rigid dowel 20 inserted across the front thereof that provides structural support to the planter pocket 14.

The hanging garden planter apparatus 10 is designed to hang vertically from a wall, door, or other similar surface. In at least one preferred embodiment, as best seen in FIG. 5, a top portion of the backing 12 is folding over and attached to the back of the backing 12 to create a looped opening 22 adapted to receive a support rod 24 therethrough. Furthermore, the top of the backing 12 includes two additional openings 26 that each expose portions of the support rod 24. The exposed portions of the support rod 24 may be suspended by hooks 28 attached to a wall or door. In at least one preferred embodiment, the hanging garden planter apparatus 10 includes hardware for attachment to a vertical surface. Examples of such hardware include hooks, screws, support rods, clips, latches, snaps, nails, and other devices facilitating attachment. In at least one alternative preferred embodiments, the hanging garden planter apparatus attached to a surface using hook and loop fasteners.

Once the hanging garden planter apparatus 10 is attached to a door, wall, or other vertical surface, a user can add soil to each of the planter pockets 14, plant seeds or sprouted plants in the soil, water the soil, and add any additional ingredients such as fertilizer to accelerate plant growth.

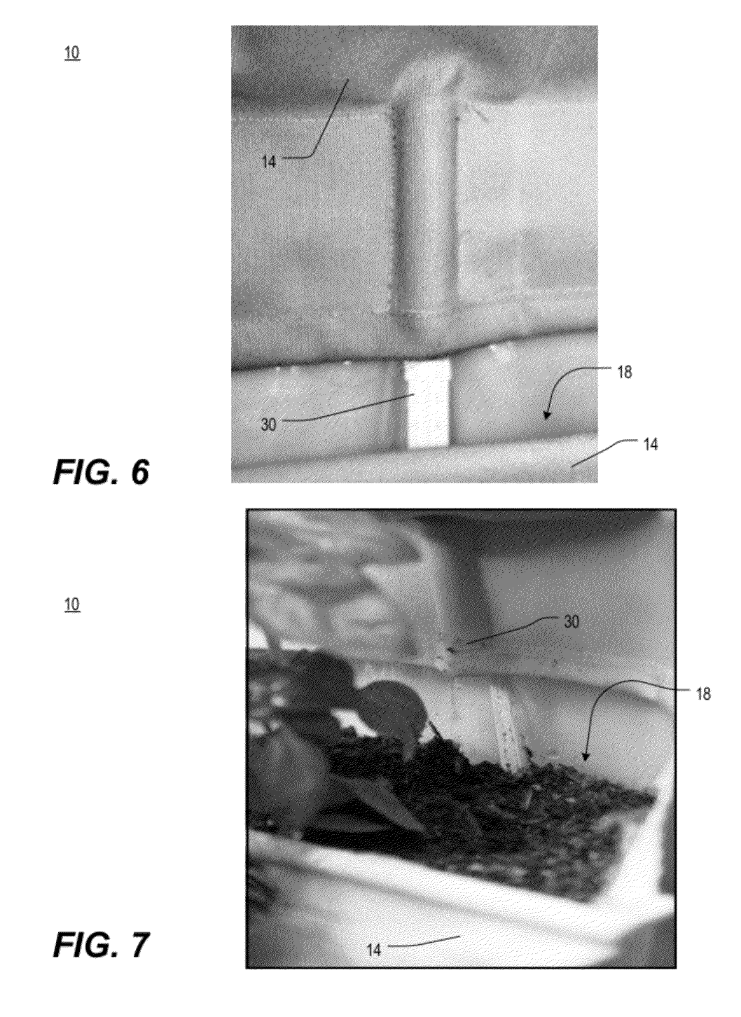

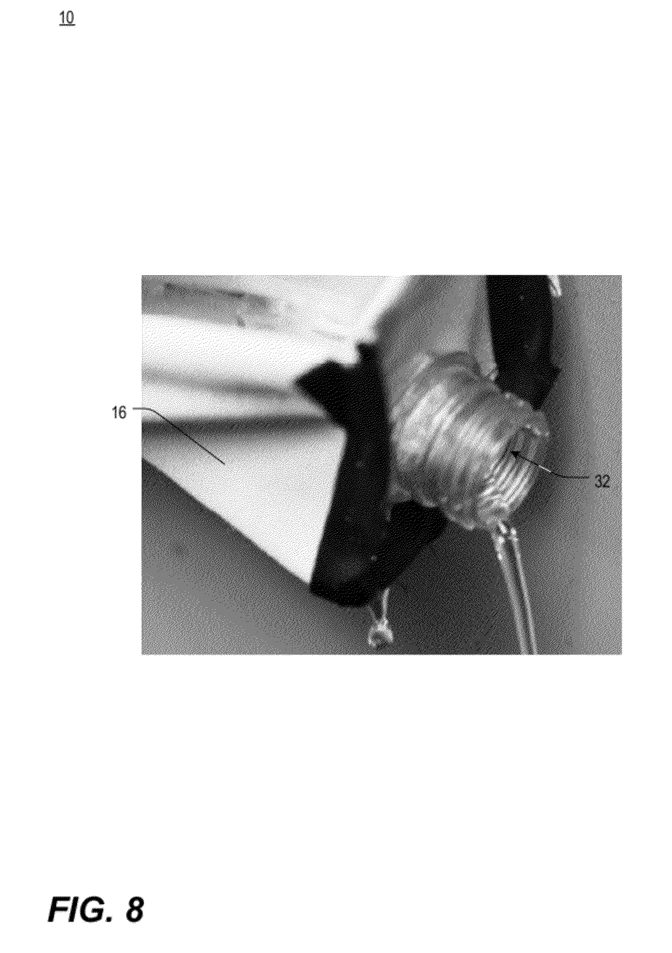

FIGS. 6-8 are illustrations of the integrated water drainage system employed by the hanging garden planter apparatus 10 of FIG. 1. As seen in FIGS. 6-8, the hanging garden planter apparatus 10 includes an integrated water drainage system. In one or more preferred embodiments, as seen in FIG. 6, the water drainage system comprises a plurality of semi-rigid tubes 30 a that run from one interior space to a vertically adjacent interior space 18. The semi-rigid tubes 30 are placed at the lowermost points of each of the planter pockets 14. As water is poured into the interior space 18 of the topmost planter pocket 14, a portion of that water is absorbed by the plants and soil housed therein. The remainder of the water flows toward the semi-rigid tubes 30, where it exits the interior space 18, and is transported to the adjacent planter pocket 14 directly below, as best seen in FIG. 7. This process repeats until the water exits the bottommost planter pocket 14. After exiting the bottommost planter pocket 14, the excess water flows into the drainage trough 16 where it is stored. In at least one preferred embodiment, as been seen in FIG. 8, the drainage trough 16 includes a sealable opening 32 that allows the excess water stored therein to be drained.

In one or more alternative preferred embodiments, the integrated drainage system is a drip watering system. The drip watering system comprises a plurality of drip openings located on the bottom of each planter pocket. The drip openings are positioned to allow water exiting each of the drip openings to fall to the adjacent planter pocket below. After exiting the drip openings of the bottommost planter pocket, the excess water falls to the drainage trough where it is stored.

The hanging garden planter apparatus 10 can be constructed from a variety of different flexible and durable materials including fabric, plastic, canvas, and various synthetic materials. In at least one preferred embodiment, the apparatus is made of a durable, ultra-violet light resistant fabric with a water resistant rubber coating.

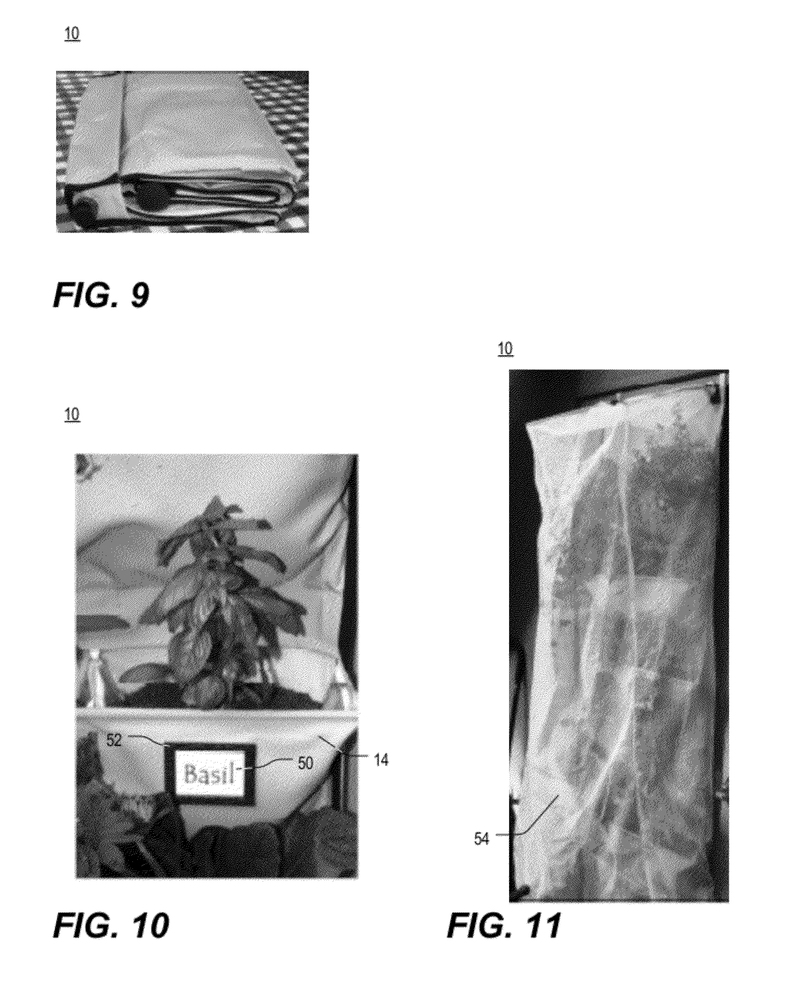

FIG. 9 is an illustration showing the hanging garden planter apparatus 10 folded to a compact size to facilitate easy storage.

FIG. 10 is an illustration of the hanging garden planter apparatus 10 of FIG. 1, further including an identification label 50 on one of the planter pockets 14. Identification labels may be either permanently affixed to the planter pockets or removably attachable. Furthermore, it is contemplated that the planter pocket 14 includes an identification label holder 52 into which the identification label 50 may be placed.

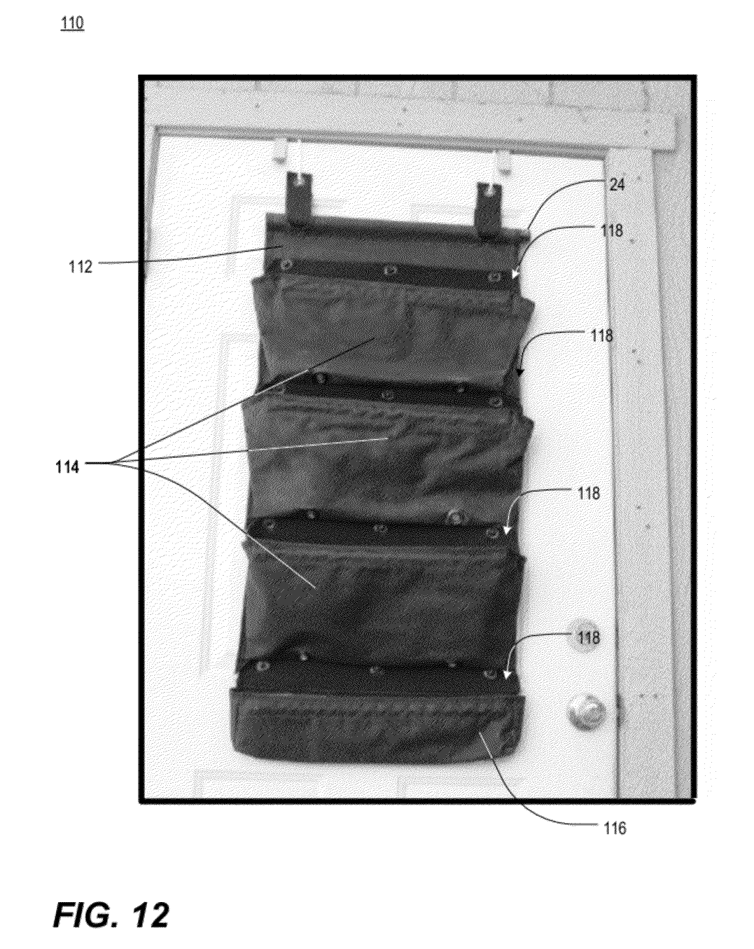

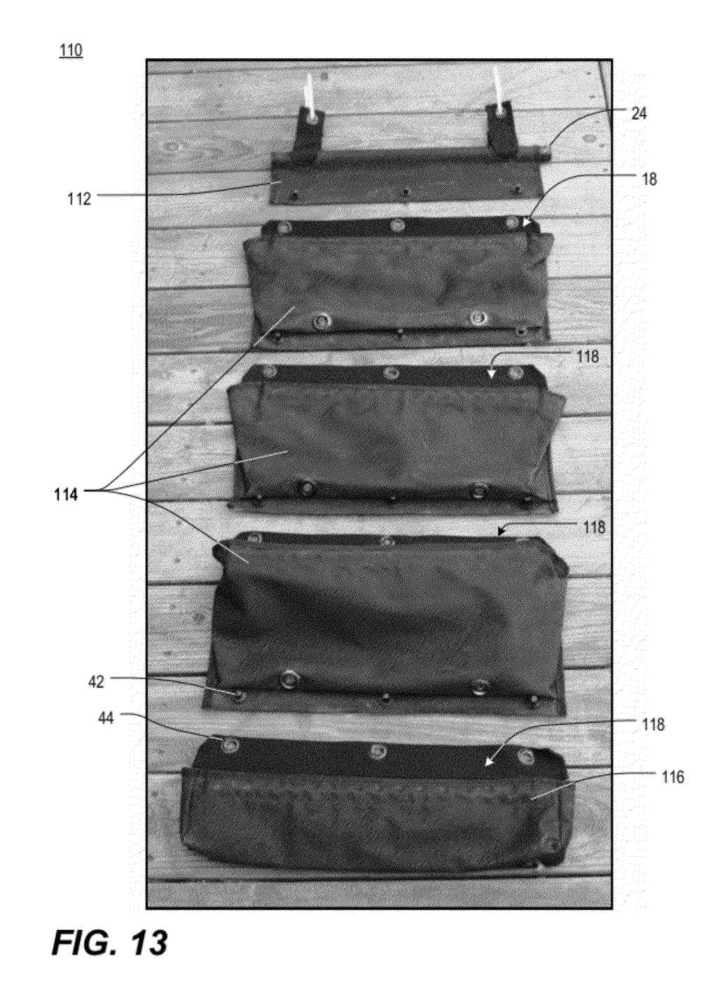

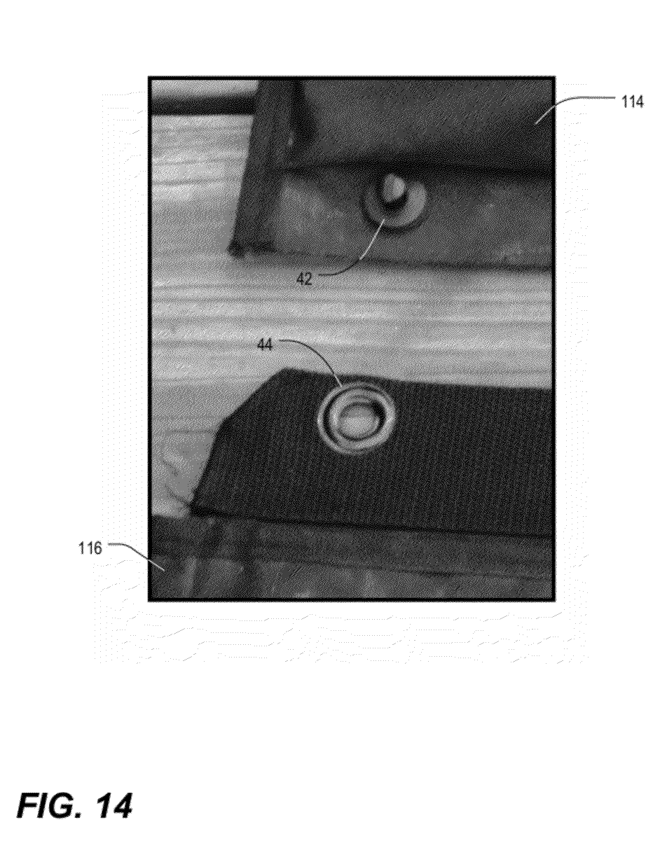

FIG. 11 is an illustration of the hanging garden planter apparatus 10 of FIG. 1, further including a removable mesh covering 54. The mesh covering 54 protects the plants from birds, rodents, bugs and other pests. The mesh covering 54 further provides shade to limit the plants' exposure to direct sunlight. In at least one contemplated embodiment, the hanging garden planter apparatus further includes a flexible, clear plastic covering that protects the plants and simultaneous simulates a greenhouse.

FIG. 12 is an illustration of another preferred embodiment of a hanging garden planter apparatus 110 in accordance with one or more aspects of the present invention. The hanging garden planter apparatus 110 of FIG. 12 is fairly similar to that of FIGS. 1-5 but has a modular construction wherein sections of the apparatus 110 may be connected and disconnected to construct an apparatus of a desired size.

As shown in FIG. 12, the hanging garden planter apparatus 110 comprises a modular backing 112, a plurality of modular, vertically aligned planter pockets 114, and a modular drainage trough 116. Each of the modular planter pockets 114 defines an interior space 118 therein adapted to house soil, plants, water, and other materials, similar to the interior spaces 18 of FIG. 2. As with the apparatus 10 of FIGS. 1-5, each planter pocket 114 includes a waterproof lining therein that prevents the water from leaking through the surface of the planter pocket 114, and in at least one preferred embodiment includes a rigid dowel, similar to that of FIG. 3, inserted across the front thereof that provides structural support to the planter pocket 114.

The hanging garden planter apparatus 110 is designed to hang vertically from a wall, door, or other similar surface. In at least one preferred embodiment, the construction of the top portion of the backing 112 is similar to that of the apparatus of FIGS. 1-5. Once the hanging garden planter apparatus 110 is attached to a door, wall, or other vertical surface, a user can add soil to each of the planter pockets 114, plant seeds or sprouted plants in the soil, water the soil, and add any additional ingredients such as fertilizer to accelerate plant growth. Other features described with reference to FIGS. 6-11 may likewise be utilized with the apparatus 110 of FIG. 12.

A notable feature of the apparatus 110 of FIG. 12 is that the modular backing 112, the modular pockets 114, and the modular drainage trough 116 may be connected and disconnected. FIG. 13 is an illustration of the hanging garden planter apparatus 110 of FIG. 12 wherein the modular backing 112, the modular pockets 114, and the modular drainage trough 116 are separated from each other. Connection may be achieved by any of a variety of means. FIG. 14 is an enlarged, fragmentary illustration of a portion of the disconnected apparatus 110 of FIG. 13. As shown therein, male and female snap features 42,44, here installed on the bottommost pocket 114 and the trough 116, respectively, are utilized, but any of a variety of other connection features may alternatively or additionally be utilized.

Based on the foregoing information, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claims appended hereto and the equivalents thereof.

What is claimed is:

1. A hanging garden planter apparatus, comprising:
(a) a backing, including a top portion adapted to hang from a vertical surface;
(b) a plurality of planter pockets vertically aligned and integral with the backing, each planter pocket of the plurality of planter pockets defining an interior space adapted to house soil and plant matter therein;
(c) a drainage trough integral with the backing, the drainage tough being positioned below the plurality of planter pockets; and
(d) an integrated drainage system;
(e) wherein the integrated drainage system is adapted to allow excess water to drain from the plurality of planter pockets to the drainage trough.

2. The hanging garden planter apparatus of claim 1, wherein the integrated drainage system comprises a plurality of semi-rigid tubes.

3. The hanging garden planter apparatus of claim 1, wherein the integrated drainage system comprises a drip watering system.

4. The hanging garden planter apparatus of claim 1, wherein each planter pocket includes a rigid dowel providing structural support.

5. The hanging garden planter apparatus of claim 1, wherein the top portion of the backing forms a looped opened adapted to receive a support rod therethrough.

6. The hanging garden planter apparatus of claim 5, wherein the top portion of the backing includes one or more openings that expose at least a portion of the support rod.

7. The hanging garden planter apparatus of claim 1, further comprising a support rod adapted to be inserted into a looped opening formed from the top portion of the backing

8. The hanging garden planter apparatus of claim 1, further comprises one or more attachment devices adapted to secure the backing to a vertical surface.

9. The hanging garden planter apparatus of claim 8, wherein the one or more attachment devices are hooks.

10. The hanging garden planter apparatus of claim 1, further comprising one or more identification labels.

11. The hanging garden planter apparatus of claim 10, further including one or more identification label holders.

12. The hanging garden planter apparatus of claim 1, further comprising a mesh covering.

13. The hanging garden planter apparatus of claim 1, further comprising a clear, plastic covering.
